(19) United States
(12) Patent Application Publication
(10) Pub. No.: US 2008/0008861 A1
(43) Pub. Date: Jan. 10, 2008

(54) Film-Covered Plastic Board and Its Composite Board

(76) Inventor: Luhao Leng, Fujian (CN)

Correspondence Address: GREER, BURNS & CRAIN, 300 S WACKER DR, 25TH FLOOR, CHICAGO, IL, 60606, US

(21) Appl. No.: 11/794,632

(22) PCT Filed: Aug. 4, 2004
(86) PCT No.: PCT/CN04/00893

§ 371 Date: Jun. 29, 2007

(30) Foreign Application Priority Data
Jan. 19, 2004 (CN) 200410023450.9
Mar. 29, 2004 (CN) 200410023863.7

(51) Int. Cl. B32B 3/00; B29C 43/00

(52) U.S. Cl. 428/156; 264/319; 428/195.1

(57) ABSTRACT

A film-covered plastic board which is constituted of a film layer having texture or pattern produced by printing and a plastic sheet, and its composite board. The film layer covers the upper surface of the plastic sheet, and the connection and fixation of the both involves directly laminating the film layer on the surface of the plastic sheet by hot pressing while the plastic sheet is being extruded by a sheet extruder.

### TECHNICAL FIELD

The present invention pertains to board processing field, in particular, to a film-covered plastic board and its composite board with the plastic board as its faceplate and soleplate.

### THE BACKGROUND OF TECHNOLOGY

Board is an important material for manufacturing the faceplate of table, the soleplate of chair, the clapboard and the bedplate of bookcase and so on. Conventional boards are mostly wood boards, but the wood will be restricted as the boards along with the reducing of the forest resources, at the same time, due to the wood boards are expensive, the production produced by the wood boards are expensive, which will affect the market of the production produced by the wood boards. Therefor, at present, the boards are mostly flakeboard, fiber board or plastic board, when using the flakeboard and fiber board, a film layer is usually added on the surface of the board, as the film layer is agglutinate with the surface of the board by the bond, the disfigurement of the board as protuberance and hollow will be obvious, which will affect the beauty of the surface of the board. When using the plastic board, for increasing the beauty of its surface, people usually print flower pattern on the surface of the plastic board, meanwhile, a layer of thermosetting oil is smeared on the surface of the plastic board to avoid printing scoring, which will make the plastic board can not be shaped by suction molding or hot pressing, consequently, shape variety of production is restricted.

### THE CONTENT OF INVENTION

The purpose of the present invention is to overcome the insufficiency of existing technology, to provide a film-covered plastic board which can be processed into the desired shape by suction molding or hot pressing, as the plastic faceplate and the plastic underplate of the foam composite board or honeycomb composite board, and it has advantages, such as, lightweight, environment friendly, easy to clean, having flexible and diverse appearance; and can replace the present wood, sliced sheet, fiber board, marble plate, etc.

The present invention adopts the technical proposal as follows: a film-covered plastic board, comprising a film layer having texture or pattern produced by printing and a plastic sheet, the film layer covers the upper surface of the plastic sheet, and the connection and fixation of the both involves directly laminating the film layer on the surface of the plastic sheet by hot pressing while the plastic sheet is being extruded by a sheet extruder.

Said film layer is a single-layered transparent film, which is unitary construction produced by calendering or blown film and whose thickness varies from 0.03 mm to 0.3 mm.

Said texture or pattern of the film layer is printed on the undersurface of the single-layered transparent film.

Said film layer is constituted of a transparent film and a film substrate, both the transparent film and the film substrate are unitary construction produced by calendering or blown film, whose thickness varies from 0.03 mm to 0.3 m m; the fixation of the transparent film and the film substrate is by hot pressing; the texture or pattern of the film layer locates between the transparent and the film substrate.

Said texture or pattern of the film layer is printed on the undersurface of the transparent film, the transparent film laminates the film substrate by hot pressing after the texture or pattern of the transparent film is printed off.

Said texture or pattern of the film layer is printed on the upper surface of the film substrate, the film substrate laminates the transparent film by hot pressing after the texture or pattern of the film substrate is printed off.

Said texture is simulated wood grain or simulated marble grain.

The present invention also can adopt another technical proposal as follows: a plastic board with printing film, comprising a printing plastic film and a plastic sheet layer, the printing plastic film covers the plastic sheet layer, the printing plastic film is constituted of a plastic film substrate and a plastic modified layer, the plastic film substrate is laminated with the plastic film substrate by blown film, cast film or calendered film; a printing surface prints in the outside surface of plastic modified layer of the printing plastic film, the printing plastic film laminates with the plastic film substrate by the printing surface of the plastic modified layer.

Said printing plastic film is printed by inner printing ink printing on the outside surface of the plastic modified layer, and the printing plastic film felts with other materials by glutinosity of the inner printing ink.

Said printing surface of the modified layer of the printing plastic film laminates the plastic sheet layer by hot pressing.

Said printing plastic film is constituted of a transparent PP/PE plastic layer and a transparent PP/PE plastic modified layer, texture or pattern prints on one side of the transparent PP/PE plastic modified layer.

Said plastic modified layer comprises macromolecular admixture of plastic substrate and modifier, the modifier includes polar group as hydroxyl group, carbonyl, carboxyl, sulfonic group, and the modifier also includes some groups having good compatibility with the materials of plastic substrate as alkyl, polyoxyethylene, ethylene and etc.

The technical proposal adopts inner printing ink, printing plastic film is printed by inner printing ink printing on the outside of the plastic modified layer, and the printing plastic film felts with other materials by glutinosity of the inner printing ink. The printing plastic film laminates the plastic sheet layer by hot pressing. The printing plastic film can replace traditional printing film, such as PVC, PET, PS, PP, PE nylon, and so on, and has advantages, such as, environment friendly, easy to clean, low cost, simple technics, that can be printed by ordinary printing ink, easy to felt with other boards, various and flexible printing pattern, and can be widely used in furniture such as table, bookshelf, cupboard, platboard, and all kinds of building board.

A composite board with the film-covered plastic board (or the plastic board with printing film) as its plastic faceplate and plastic underplate, the film-covered board is processed into the desired shape by suction molding or hot pressing, then is cut to the plastic faceplate and the plastic underplate having the size desired by the composite board, and then filling up piece and liner piece are put between the plastic faceplate and the plastic underplate, to form the composite board; wherein, the edge of the plastic faceplate and the edge of the plastic underplate splice with one another and the joints fixedly connect with each other; the filling up piece may be plastic foam piece or honeycomb core.

A composite board with the film-covered plastic board (or the plastic board with printing film) as its plastic faceplate and plastic underplate, the film-covered board (or the plastic board with printing film) is processed into the desired shape by suction molding or hot pressing, then is cut to the plastic faceplate and the plastic underplate having the size desired by the composite board, and then filling up piece and border connecting fitting are put between the plastic faceplate and the plastic underplate, to form the composite board; wherein, the border connecting fitting entirely or partly covers the circumference of the filling up piece and fixedly connect with the filling up piece; the edge of the plastic faceplate and the edge of the plastic underplate inosculate with the figure of the filling up piece and fixedly connect with the filling up piece; the filling up piece may be plastic foam piece or honeycomb core.

In producing, if the polarity of the film and the polarity of the plastic sheet is same, for example, the plastic is ABS, the film can be crossblend of ABS, PMMA, PC, PP and ELVOLOY. When the film layer is a single-layered transparent film, which is unitary construction produced by calendering or blown film and whose thickness varies from 0.03 mm to 0.3 mm. Texture or pattern of the film layer is printed on the undersurface of the single-layered transparent film by film imprinter, then, directly laminating the single-layered transparent film on the upper surface of the plastic sheet by hot pressing while the plastic sheet is being extruded by a sheet extruder, which doesn't need adhesive, on the other hand, texture and pattern of boards doesn't locate on the surface of the boards to avoid the texture and pattern scrape or depigmentize. When the film layer is constituted of a transparent film and a film substrate, both the transparent film and the film substrate are unitary construction produced by calendering or blown film, whose thickness varies from 0.03 mm to 0.3 mm; here texture or pattern of the film layer can be printed on the undersurface of the transparent film, and also can be printed on the upper surface of the film substrate, the transparent film laminates the film substrate by hot pressing after the texture or pattern is printed off; here the texture or pattern locates between film layers, texture and pattern of boards doesn't locates on the surface of the boards to avoid the texture and pattern scrape or depigmentize. Then, directly laminating the film layer on the upper surface of the plastic sheet by hot pressing while the plastic sheet is being extruded by a sheet extruder, to form film-covered plastic board. The thickness of plastic sheet varies from 0.3 mm to 4 mm. The film-covered board is processed into the desired shape by suction molding or hot pressing, then is cut to the plastic faceplate and the plastic underplate having the size desired by the composite board, and then is laminated with filling up piece or liner piece or border connecting fitting to form the composite board which can be widely used in furniture such as table, bookshelf, cupboard, platboard and etc, and all kinds of building board.

The present invention has advantages as follows: the film-covered plastic board is constituted of a film layer having texture or pattern produced by printing and a plastic sheet, laminating the film layer on the surface of the plastic sheet by hot pressing while the plastic sheet is being extruded by a sheet extruder. In this way, it doesn't need adhesive, on the other hand, the film-covered plastic board is easy to processed into the desired shape by suction molding or hot pressing, then is cut to the plastic faceplate and the plastic underplate having the size desired by the composite board, and then is laminated with honeycomb board or plastic foam to form the composite board which can replace the present wood, sliced sheet, fiber board, marble plate, etc, and can be widely used in furniture such as table, bookshelf, cupboard, platboard and etc, and all kinds of building board and has the advantages, such as, lightweight, environment friendly, easy to clean, having flexible and diverse appearance. Film layers have simulated wood grain or simulated marble grain or other appearance patterns, which greatly increases applicability and aesthetics of boards; the texture and pattern locates on the undersurface of the single-layered transparent film or the undersurface of the transparent film of film layer or the upper surface of film substrate of film layer, which can avoid the texture and pattern scrape or depigmentize.

### THE BRIEF INTRODUCTION OF ATTACHED DRAWINGS

FIG. 1 is explosion views of the film-covered plastic board of embodiment 1;

FIG. 2 is explosion views of the film-covered plastic board of embodiment 2;

FIG. 3 is explosion views of the film-covered plastic board of embodiment 3;

FIG. 4 is part sectioned view of the composite board of embodiment 4;

FIG. 5 is part sectioned view of the composite board of embodiment 5;

FIG. 6 is part sectioned view of the composite board of embodiment 6;

FIG. 7 is part sectioned view of the composite board of embodiment 7.

### EMBODIMENT

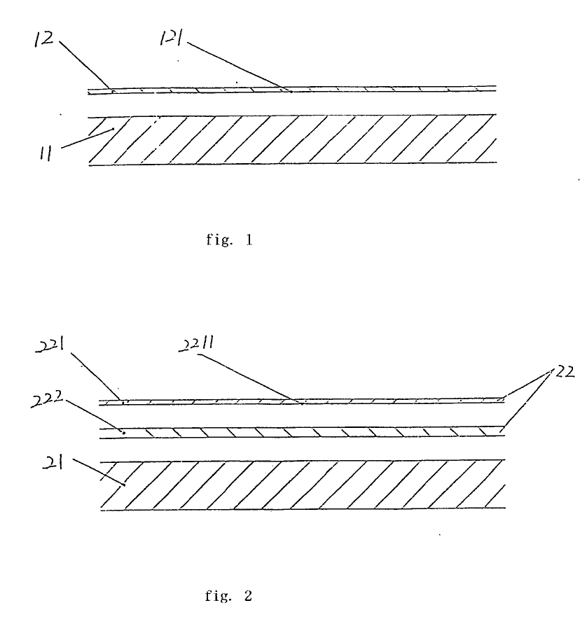

Embodiment 1, referring to FIG. 1, a film-covered plastic board, comprising a film layer 12 and a plastic sheet 11, the film layer 12 is a single-layered transparent film, which is unitary construction produced by calendering or blown film and whose thickness varies from 0.03 mm to 0.3 mm. The undersurface 121 of the transparent film 12 has texture or pattern produced by printing, in which the texture can be simulated wood grain or simulated marble grain; the film layer 12 covers the upper surface of the plastic sheet 11, and the connection and fixation of the both involves directly laminating the film layer 12 on the surface of the plastic sheet 11 by hot pressing while the plastic sheet 11 is being extruded by a sheet extruder.

In producing, the polarity of the transparent film 12 and the polarity of the plastic sheet 11 must be the same, for example, if the plastic is ABS, the film can be ABS, PMMA, PC and so on. The transparent film 12 is unitary construction produced by calendering or blown film and whose thickness varies from 0.03 mm to 0.3 mm, in advance, texture or pattern of the film layer is printed on the undersurface 121 of the single-layered transparent film 12 by film imprinter, then, directly laminating the single-layered transparent film 12 on the upper surface of the plastic sheet 11 by hot pressing while the plastic sheet 11 is being extruded by a sheet extruder, which doesn't need adhesive, on the other hand, texture and pattern of boards doesn't locate on the surface of the boards to avoid the texture and pattern scrape or depigmentize. The thickness of the plastic sheet 11 varies from 0.3mm to 4mm, laminating the transparent film 12 on the plastic sheet 11 to form film-covered plastic board.

Embodiment 2, referring to FIG. 2, a film-covered plastic board, comprising a film layer 22 and a plastic sheet 21, thereinto, the film layer 22 is constituted of a transparent film 221 and a film substrate 222, both the transparent film 221 and the film substrate 222 are unitary construction produced by calendering or blown film, whose thickness varies from 0.03 mm to 0.3 mm; the undersurface 2211 of the transparent film 221 has texture or pattern produced by printing, in which the texture can be simulated wood grain or simulated marble grain; the fixation of the transparent film 221 and the film substrate 222 is by hot pressing; the film layer 22 covers the upper surface of the plastic sheet 21, and the connection and fixation of the both involves directly laminating the film layer 22 on the surface of the plastic sheet 21 by hot pressing while the plastic sheet 21 is being extruded by a sheet extruder.

In producing, the polarity of the film layer 22 and the polarity of the plastic sheet 21 must be the same, the film layer 22 is constituted of a transparent film 221 and a film substrate 222, both the transparent film 221 and the film substrate 221 are unitary construction produced by calendering or blown film, whose thickness varies from 0.03 mm to 0.3 mm; here texture or pattern is printed on the undersurface 2211 of the transparent film 221, after the fixation of the transparent film 221 and the film substrate 222 is by hot pressing, to form film layer 22; texture and pattern of boards doesn't locate on the surface of the boards to avoid the texture and pattern scrape or depigmentize. Then, directly laminating the film layer 22 on the upper surface of the plastic sheet 21 by hot pressing while the plastic sheet 21 s being extruded by a sheet extruder, to form film-covered plastic board.

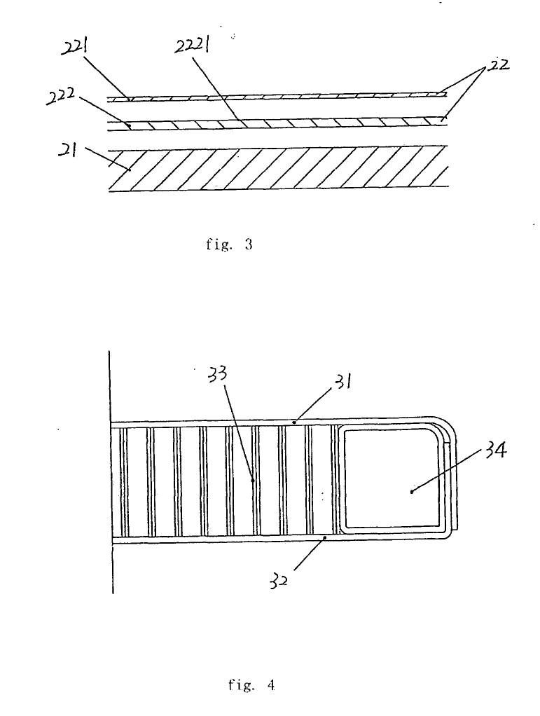

Embodiment 3, referring to FIG. 3, a film-covered plastic board, the difference with the embodiment 2 is: the texture and pattern of the film layer 22 are printed on the upper surface 2221 of the film substrate 222.

Embodiment 4, referring to FIG. 4, a composite board with film-covered plastic board as its plastic faceplate 31 and plastic underplate 32, the film-covered plastic board is processed into the desired shape by suction molding or hot pressing, then is cut to the plastic faceplate 31 and the plastic underplate 32 having the size desired by the composite board, and then filling up piece 33 and liner piece 34 are put between the plastic faceplate and the plastic underplate, to form the composite board; wherein, the edge of the plastic faceplate 31 and the edge of the plastic underplate 32 splice with one another, the plastic underplate 32 covers the underside and the outer side of the liner piece 34, the plastic faceplate 31 covers the uppersurface of the liner piece 34 and edges of the plastic underplate 32, and the edge of the plastic faceplate 31 and the edge of the plastic underplate 32 splice with one another and the joints fixedly connect with each other; the filling up piece 33 may be plastic foam piece or honeycomb core. The composite board can replace the present wood, sliced sheet, fiber board, marble plate, etc, and can be widely used in furniture such as table, bookshelf, cupboard, platboard and etc, and all kinds of building board.

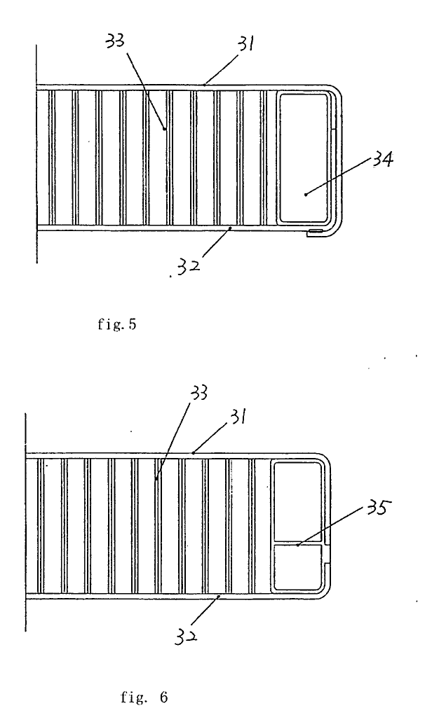

Embodiment 5, referring to FIG. 5, a composite board with film-covered plastic board as its plastic faceplate 31 and plastic underplate 32, the difference with the embodiment 4 is: the plastic faceplate 31 bends downwards to cover the undersurface of the composite board, and fixedly connects with plastic underplate 32 on the undersurface.

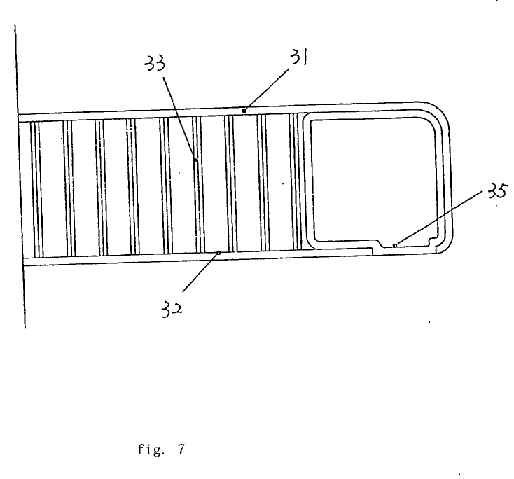

Embodiment 6, referring to FIG. 6, a composite board with film-covered plastic board as its plastic faceplate 31 and plastic underplate 32, the difference with the embodiment 4 is: it adopts the border connecting fitting 35 to replace the liner piece, the border connecting fitting 35 entirely or partly covers the circumference of the filling up piece 33 and fixedly connect with the filling up piece 33; the edge of the plastic faceplate 31 and the edge of the plastic underplate 32 inosculate with the figure of the border connecting fitting 35 and fixedly connect with the border connecting fitting 35; the plastic faceplate 31 covers the upper surface and part of side of the border connecting fitting 35, and connects fixedly with the border connecting fitting 35, the plastic underplate 32 covers the undersurface and part of side of the border connecting fitting 35, and connects fixedly with the border connecting fitting 35, the filling up piece 33 can be honeycomb core or plastic foam.

Embodiment 7, a composite board with film-covered plastic board as its plastic faceplate 31 and plastic underplate 32, the difference with the embodiment 4 is: the plastic faceplate 31 covers the upper surface and the side of the border connecting fitting 35, and connects fixedly with the border connecting fitting 35, the plastic underplate 32 covers the undersurface of the border connecting fitting 35, and connects fixedly with the border connecting fitting 35.

Embodiment 8, a plastic board with printing film, comprising a printing plastic film and a plastic sheet, the printing plastic film is constituted of a transparent PP/PE plastic film layer and a transparent PP/PE plastic modified layer, the transparent PP/PE plastic film layer is laminated with the transparent PP/PE plastic modified layer by blown film, cast film or calendered film, without bond; thereinto, the transparent PP/PE plastic modified layer comprises plastic substrate and macromolecular admixture as modifier, the modifier includes polar group as hydroxyl group, carbonyl, carboxyl, sulfonic group, to improve the polarity and surface energy of the surface of the modified layer, to improve the compatibility of the surface of the modified layer and printing ink; and the modifier also includes some groups having good compatibility with the materials of plastic substrate as alkyl, polyoxyethylene, ethylene and etc. for example, the transparent plastic layer can be PP, the transparent modified plastic layer can be admixture of PP and ELVALOY1820 AC, ELVALOY1125 AC or other modifiers; the thickness of the printing plastic film layer varies from 0.03 mm to 0.3 mm, the thickness of the transparent modifier layer varies from 0.01 mm to 0.25 mm, the percent of the modifier can be from 1 to 90. The printing plastic film is printed by inner printing ink printing on the outside of the plastic modified layer, and the printing plastic film felts with other materials by glutinosity of the inner printing ink, the printing surface of the modified layer of the printing plastic film laminates the plastic substrate by hot pressing, to form a plastic board with printing film. Here the pattern of board doesn't locate on the surface of the plastic board to avoid the texture and pattern scrape or depigmentize. Here the plastic substrate is single-layered plastic sheet, whose thickness varies from 0.3 mm to 4 mm, and can be processed into the desired shape by suction molding or hot pressing, and the materials can be ABS, PP, PS and so on.

### INDUSTRY PRACTICABILITY

The film-covered board is processed into the desired shape by suction molding or hot pressing, then is cut to the plastic faceplate and the plastic underplate having the size desired by the composite board, and then is laminated with honeycomb board or plastic foam to form the composite board which can replace the present wood, sliced sheet, fiber board, marble plate, etc, and can be widely used in furniture such as table, bookshelf, cupboard, platboard and etc, and all kinds of building board.

1. A film-covered plastic board, comprising: a film layer having a texture or pattern produced by printing and a plastic sheet, the film layer covers an upper surface of the plastic sheet, and the connection and fixation of the layer to the sheet involves directly laminating the film layer on the surface of the plastic sheet by hot pressing while the plastic sheet is extruded by a sheet extruder.

2. A film-covered plastic board according to claim 1 wherein said film layer is a single-layered transparent film, which is of unitary construction produced by calendering or blown film and whose thickness varies from 0.03 mm to 0.3 mm.

3. A film-covered plastic board according to claim 2 wherein said texture or pattern of the film layer is printed on the undersurface of the single-layered transparent film.

4. A film-covered plastic board according to claim 1 wherein said film layer is constituted of a transparent film and a film substrate, both the transparent film and the film substrate are of unitary construction produced by calendering or blown film, whose thickness varies from 0.03 mm to 0.3 mm; the fixation of the transparent film and the film substrate is by hot pressing; the texture or pattern of the film layer locates is located between the transparent and the film substrate.

5. A film-covered plastic board according to claim 4 wherein said texture or pattern of the film layer is printed on the undersurface of the transparent film, the transparent film is laminated to the film substrate by hot pressing after the texture or pattern of the transparent film is printed off.

6. A film-covered plastic board according to claim 4 wherein said texture or pattern of the film layer is printed on the upper surface of the film substrate, the film substrate is laminated to the transparent film by hot pressing after the texture or pattern of the film substrate is printed off.

7. A plastic board with printing film, comprising: a printing plastic film and a plastic sheet layer, the printing plastic film covers the plastic sheet layer, the printing plastic film is constituted of a plastic film substrate and a plastic modified layer, the plastic film substrate is laminated with the plastic modified layer by blown film, cast film or calendered film; a printing surface prints on the outside of the plastic modified layer of the printing plastic film, the printing plastic film is laminated to the plastic film substrate by the printing surface of plastic modified layer.

8. A plastic board with printing film according to claim 7 wherein said printing plastic film is printed by inner printing ink printing on the outside of the plastic modified layer, and the printing plastic film felts with other materials by glutinosity of the inner printing ink.

9. A plastic board with printing film according to claim 7 wherein said printing surface of the modified layer of the printing plastic film laminates the plastic sheet layer by hot pressing.

10. A plastic board with printing film according to claim 7 wherein said printing plastic film is constituted of a transparent PP/PE plastic layer and a transparent PP/PE plastic modified layer, texture or pattern prints on one side of the transparent PP/PE plastic modified layer.

11. A method for making a composite board, the comprising: processing a film-covered board into the desired shape by suction molding or hot pressing, then the board is cut to the plastic faceplate and the plastic underplate having the size desired by the composite board, and then a filling up piece and a liner piece are put between the plastic faceplate and the plastic underplate, to form the composite board; wherein, the edge of the plastic faceplate and the edge of the plastic underplate splice with one another and the joints are fixedly connected with each other; the filling up piece may be a plastic foam piece or a honeycomb core.

12. A composite board made by the method comprising: processing a, film-covered board into the desired shape by suction molding or hot pressing, then the board is cut to the plastic faceplate and the plastic underplate having the size desired by the composite board, and then a filling up piece and a border connecting fitting are put between the plastic faceplate and the plastic underplate, to form the composite board; wherein, the border connecting fitting entirely or partly covers the circumference of the filling up piece and fixedly connects with the filling up piece; the filling up piece; the edge of the plastic faceplate and the edge of the plastic underplate inosculate with the figure of the border, connecting fitting and fixedly connect with the border connecting fitting; the filling up piece may be a plastic foam piece or a honeycomb core.
